(19) United States
(12) Patent Application Publication
(10) Pub. No.: US 2013/0104850 A1
(43) Pub. Date: May 2, 2013

(54) MULTI-FUEL PRE-MIXED COMBUSTION SYSTEM OF INTERNAL COMBUSTION ENGINE

(71) Applicants: Wuqiang Long, Liaoning (CN); Jiangping Tian, Liaoning (CN); Xianyin Leng, Liaoning (CN); Kunpeng Qi, Liaoning (CN); Kai Sheng, Liaoning (CN); Quan Dong, Liaoning (CN)

(72) Inventors: Wuqiang Long, Liaoning (CN); Jiangping Tian, Liaoning (CN); Xianyin Leng, Liaoning (CN); Kunpeng Qi, Liaoning (CN); Kai Sheng, Liaoning (CN); Quan Dong, Liaoning (CN)

(73) Assignee: DALIAN UNIVERSITY OF TECHNOLOGY, Liaoning (CN)

(21) Appl. No.: 13/807,446

(22) PCT Filed: Jun. 22, 2011
(86) PCT No.: PCT/CN2011/001042

§ 371 Date: Dec. 28, 2012

(30) Foreign Application Priority Data
Jun. 28, 2010 (CN) 201010215790.7
Jun. 19, 2011 (CN) 201110165098.2

(51) Int. Cl. F02M 39/00

(52) U.S. Cl. CPC F02M 39/00
USPC 123/445

(57) ABSTRACT

A multi-fuel pre-mixed combustion system of an internal combustion engine includes a main fuel spray nozzle (2), which injects a mixed fuel of compression-ignition-suitable fuels, spark-ignition-suitable fuel, or a wide cut fuel to form a homogeneous primary pre-mixed gas. An auxiliary spray nozzle (4) injects a spark-ignition-suitable fuel to form a secondary mixed gas, which is ignited by the spark plug (3) by means of spray guiding or an ignition chamber (5), and the primary pre-mixed gas in the combustion chamber (1) is compression ignited. Consequently, the ignition point of the primary mixed gas is effectively controlled and knock is avoided, and a homogeneous pre-mixed compression ignition is achieved over the whole range of operating conditions. The combustion rate is controlled by exhaust gas recirculation or spray of water into a cylinder or intake port, and high thermal efficiency is ensured by a high expansion ratio.

### FIELD OF THE INVENTION

The present invention relates to multi-fuel pre-mixed combustion system of internal combustion engines, which belongs to the combustion areas of internal combustion engine.

### BACKGROUND OF THE INVENTION

It is well known that on one hand, fuel diversification progress of internal combustion engine is accelerating, on the other hand, the technology of diesel and gasoline engines become more and more complex and their costs get more and more expensive in order to meet increasingly stringent emission regulations and the requirements of fuel economy. Especially, the rapid development of electric vehicle and hybrid electric vehicle technology brings a serious challenge against the internal combustion engine.

### SUMMARY OF THE INVENTION

For solving the fuel adaptability problems, improving performance, and reducing costs of the internal combustion engine to enhance the competitiveness, the present invention provides a multi-fuel pre-mixed combustion system of an internal combustion engine. This combustion system should adopt low compression ratio; supercharging air cooling or water injection in the port or water injection in the cylinder should be undertaken for the supercharged engine to avoid auto-ignition of the primary mixture with main spray nozzle in the intake stroke or compression stroke, which is formed by injecting fuel suitable for compression ignition, or blended fuel comprising fuels suitable for compression ignition and spark ignition, or wide-cut fuel. At about TDC (Top Dead Center), the fuel suitable for spark ignition or the same fuel as injected by the main fuel spray nozzle is injected. Then the mixture in main combustion chamber is ignited with spray guiding way or ignition chamber way. Thus the ignition timing of the multi-fuel premixed combustion can be controlled effectively. In this combustion system, EGR (Exhaust Gas Recirculation) or water direct injection in combustion chamber or water injection in the port are utilized to control the combustion rate, the premixed combustion of the multi-fuel or the wide-cut fuel with controllable ignition phase and the combustion rate is achieved to maintain high thermo efficiency.

The technical solution of the present invention is: A premixed combustion system employing multi-fuel in internal combustion engines, comprising a combustion chamber, a main spray nozzle, a spark plug, and an auxiliary spray nozzle. Said main spray nozzle is installed in the combustion chamber or the intake port, the primary premixed mixture is formed by blended fuel which is comprised of two or more compression-ignition-suitable fuel, or by blended fuel which is comprised of the compression-ignition-suitable fuel and spark-ignition-suitable fuel, or by wide-cut fuel, which is injected from the main spray nozzle into the combustion chamber or intake port during intake stroke or compression stroke. Proper fuel design can ensure this blended fuel or wide-cut fuel having a better atomization performance than diesel fuel, easier to be evaporated and the compression end temperature can be decreased. The engine can be natural aspirated or supercharged. The effective compression ratio is set less than or equal to 14 with regard to natural aspirated; when it is supercharged, the effective compression ratio is set no more than 11. The supercharged air is cooled by a supercharger cooler, or by intake port water injection, or by direct water injection into the combustion chamber to decrease the compression temperature of intake charge, to avoid the auto-ignition of the primary premixed mixture in the combustion chamber caused by temperature rise due to compression. The secondary mixture suitable for spark ignition is formed around the spark plug electrode by injecting a spark-ignition-suitable fuel or the same fuel as injected by the main spray nozzle with an auxiliary spray nozzle just before or after TDC (Top Dead Center), and then the secondary mixture is ignited by a spark plug, leading to the rapid rise of pressure and temperature which triggers the multi-point simultaneous premixed compression ignition of the primary mixture in all the space of combustion chamber.

Said main spray nozzle, spark plug and auxiliary spray nozzle are installed in combustion chamber.

An ignition chamber is set in the cylinder head, said main spray nozzle is installed in combustion chamber, the spark plug and the auxiliary spray nozzle are installed in the ignition chamber, and there is at least one connecting channel between the combustion chamber and ignition chamber.

A water injector is set in the said combustion chamber.

A water injector is set in the said intake port.

When the said spark plug and auxiliary spray nozzle are set in the combustion chamber, the main spray nozzle and the water injector are set in the intake port.

When the said spark plug and auxiliary spray nozzle are set in the ignition chamber, the main spray nozzle and water injector are set in the intake port.

When the said spark plug and auxiliary spray nozzle are set in the ignition chamber, the main spray nozzle is set in the intake port and the water injector is set in combustion chamber.

When said spark plug, auxiliary spray nozzle and the water injector are set in the combustion chamber, main spray nozzle is set in the intake port.

EGR technique is used in the said internal combustion engine.

Both the main spray nozzle and the auxiliary spray nozzle are shut off in the idle condition when the said internal engine is used as a vehicle power.

The guiding ideology of the above technical solutions is: it is difficult to control the auto-ignition timing (combustion phase) of a premixed mixture for premixed combustion systems. By decreasing the compression ratio and the temperature of intake air to decrease the temperature of the compression end in the cylinder, the spontaneous auto-ignition of the primary mixture in the cylinder only relying on compression temperature can be avoided. A secondary mixture is formed with fuel injection by an auxiliary spray nozzle, where the fuel refers to that suitable for spark ignition or the same as the fuel injected by the main spray nozzle. Then the secondary mixture is ignited by spark and the primary mixture is ignited with the high pressure and temperature generated by the combustion of the secondary mixture. In order to ensure the stable ignition of the spark-ignition-suitable fuel or the same fuel as injected by the main spray nozzle, a spray-guided mode or an ignition chamber structure is adopted. High expansion ratio can improve the fuel efficiency and reduce the fuel consumption rate. In order to control premixed compression ignition combustion rate of the multi-fuel, EGR and water injection technology are used to import part of the exhaust gas and water into the cylinder to reduce the combustion temperature.

The benefits of this invention are: in this multi-fuel premixed combustion system of internal combustion engine, a low compression ratio and a high expansion ratio are adopted. For supercharged internal combustion engine, enhanced cooling of intake charge is used to avoid auto-ignition of primary premixed mixture in the cylinder. Then a secondary mixture is formed with fuel injection by an auxiliary spray nozzle, where the fuel is suitable for spark ignition or the same as the fuel injected by the primary spray nozzle. Then the secondary mixture is ignited by a spark and then the primary mixture is ignited with the high pressure and temperature generated by the combustion of the secondary mixture, so as to control the premixed combustion ignition timing effectively. To control combustion rate of multi-fuel premixed combustion, EGR and the technology of water injection into cylinder are applied. Thus ignition timing and combustion rate of the multi-fuel premixed combustion can be controlled within the full range of operating conditions, to get ultra-low NOx and soot emissions and to maintain high efficiency at the same time. This internal combustion engine is adapted to a variety of fuels, and the emission after-treatment system is also relatively simple. Directly injecting mixture of diesel fuel and blended fuel that has high volatility such as gasoline and ethanol can decrease the temperature in cylinder and firing point of the primary mixture. Hence the compression ratio of the engine is not necessarily to be very low, which is helpful in keeping the high thermo efficiency of the engine. Moreover, the cold start problem of premixed compression combustion can be avoided effetely by igniting the primary mixture with the combustion of the secondary mixture. The test on a 135 mm bore single cylinder diesel engine showed that NOx emissions decreased by 96%, soot emissions decreased by 92%, while thermal efficiency increased by 3%. In particular, this multi-fuel combustion system can use a mixture of diesel and gasoline, so fuel refinery may not necessarily separate diesel and gasoline, which helps to reduce the refining costs. Of course, the multi-fuel combustion system can also inject a single liquid fuel suitable for spark ignition, to form primary premixed mixture, and the secondary air-fuel mixture is formed by injecting gas fuel. A better performance can be obtained by igniting the primary mixture with the high temperature generated by the combustion of the secondary mixture.

### BRIEF DESCRIPTION OF THE DRAWINGS

The present invention is explained in more detail below with reference to the exemplary embodiments and the attached figures, in which:

FIG. 1 is the sketch map of the multi-fuel premixed combustion system of ICE (Internal Combustion Engine) adopting spray-guided ignition.

FIG. 2 is the sketch map of the multi-fuel premixed combustion system with ignition chamber.

FIG. 3 is the sketch map of the multi-fuel premixed combustion system adopting ignition chamber with a water injector set in combustion chamber.

FIG. 4 is the sketch map of the multi-fuel premixed combustion system of ICE adopting spray-guided ignition with a water injector set in combustion chamber.

FIG. 5 is the sketch map of the multi-fuel premixed combustion system adopting ignition chamber with a water injector set in intake port.

FIG. 6 is the sketch map of the multi-fuel premixed combustion system of ICE adopting spray-guided ignition with a water injector set in intake port.

FIG. 7 is the sketch map of the multi-fuel premixed combustion system adopting ignition chamber with a main spray nozzle and a water injector set in intake port.

FIG. 8 is the sketch map of the multi-fuel premixed combustion system of ICE adopting spray-guided ignition with a main spray nozzle and a water injector set in intake port.

FIG. 9 is the sketch map of the multi-fuel premixed combustion system adopting ignition chamber with a main spray nozzle set in intake port and a water injector set in combustion chamber.

FIG. 10 is the sketch map of the multi-fuel premixed combustion system of ICE adopting spray-guided ignition with main spray nozzle set in intake port and a water injector set in combustion chamber.

In the figure:
1. Combustion chamber,
2. Main spray nozzle,
3. Spark plug,
4. Auxiliary spray nozzle,
5. Ignition chamber,
6. Connection channels,
7. Water injector,
8. Intake port

### DETAILED DESCRIPTION OF THE PREFERRED EMBODIMENT

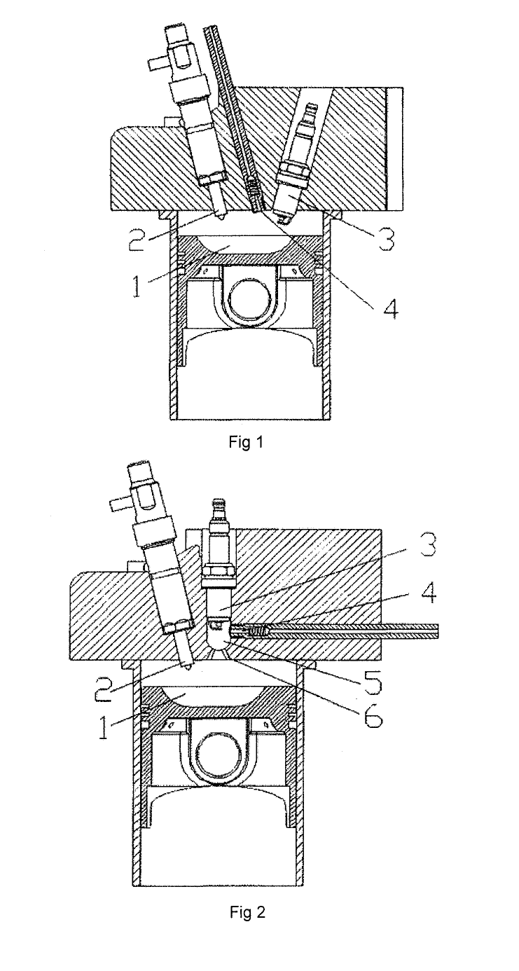

FIG. 1 shows that the main spray nozzle 2, spark plug 3, and auxiliary spray nozzle 4 of an internal combustion engine are installed in the combustion chamber 1.

FIG. 2 shows that main spray nozzle is installed in the combustion chamber 1, the spark plug 3 and auxiliary spray nozzle 4 of an internal combustion engine are installed in ignition chamber 5. The combustion chamber 1 and the ignition chamber 5 are connected through at least one connecting channel 6.

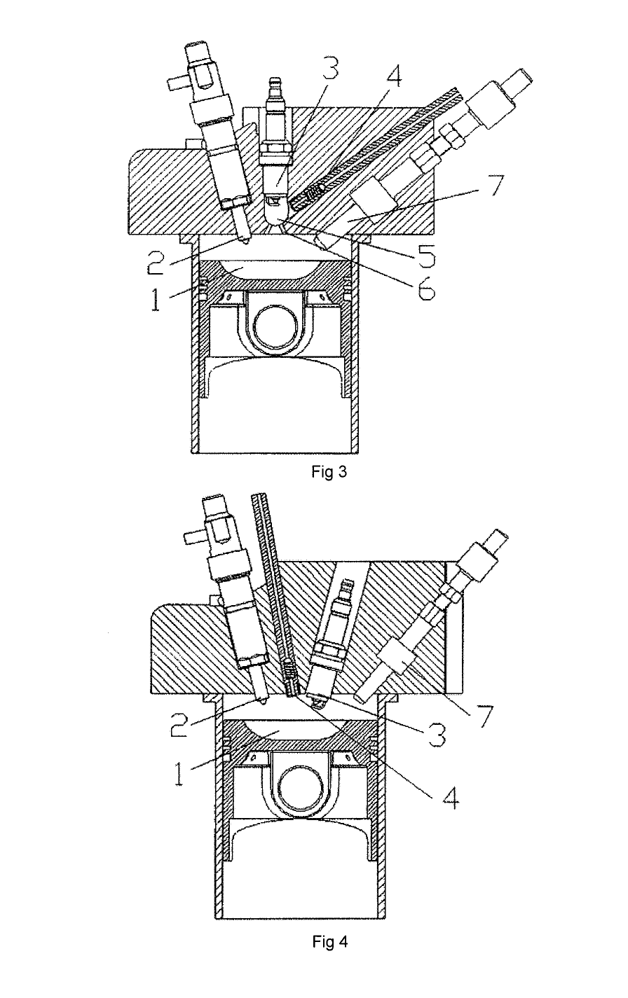

FIG. 3 shows that the main spray nozzle 2 is installed in combustion chamber 1, spark plug 3 and auxiliary spray nozzle 4 of an internal combustion engine are installed in ignition chamber 5, combustion chamber and ignition chamber is connected through at least one connection channel 6, and the water injector 7 is installed in combustion chamber 1.

FIG. 4 shows that main spray nozzle 2, spark plug 3 and auxiliary spray nozzle 4 of an internal combustion engine are installed in combustion chamber 1, and the water injector 7 is installed in combustion chamber 1 as well.

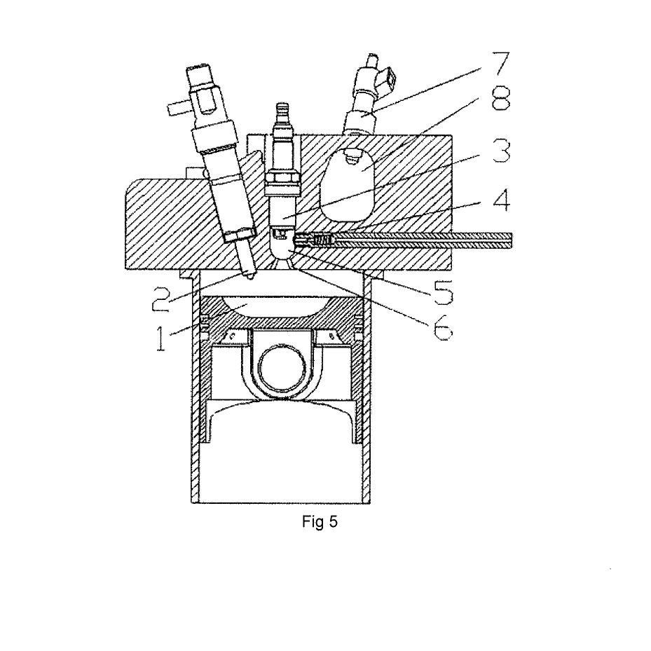

FIG. 5 shows that the main spray nozzle 2 of an internal combustion engine is installed in combustion chamber 1, spark plug 3 and auxiliary spray nozzle 4 are installed in ignition chamber 5, combustion chamber 1 and ignition chamber 5 are connected through at least one connection channel 6, and water injector 7 is installed in intake port 8.

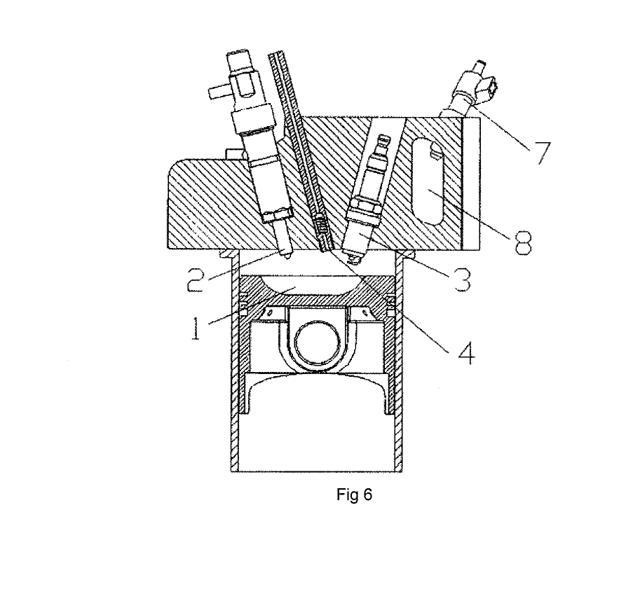

FIG. 6 shows that the main spray nozzle 2, spark plug 3 and auxiliary spray nozzle 4 of an internal combustion engine are installed in combustion chamber 1, and water injector 7 is installed in intake port 8.

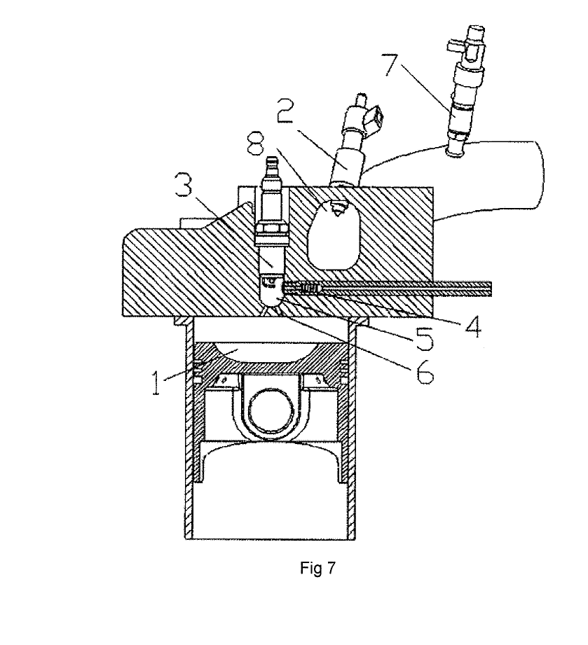

FIG. 7 shows that spark plug 3 and auxiliary spray nozzle 4 of an internal combustion engine are installed in ignition chamber 5, combustion chamber 1 and ignition chamber 5 are connected through at least one connection channel 6. The main spray nozzle 2 and the water injector 7 are installed in intake port 8.

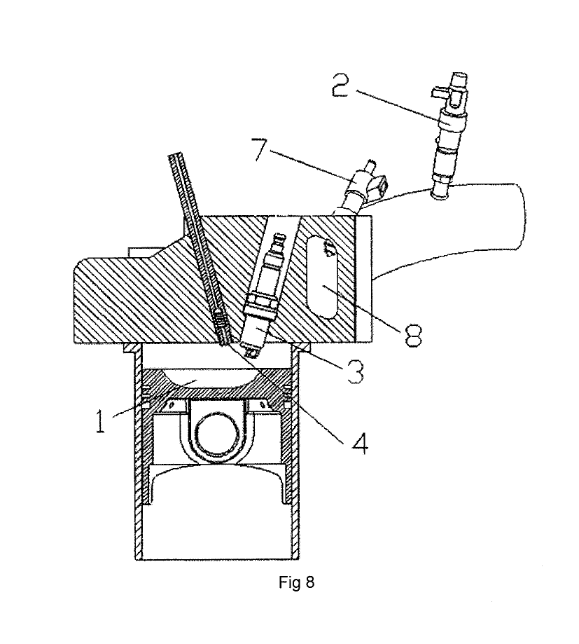

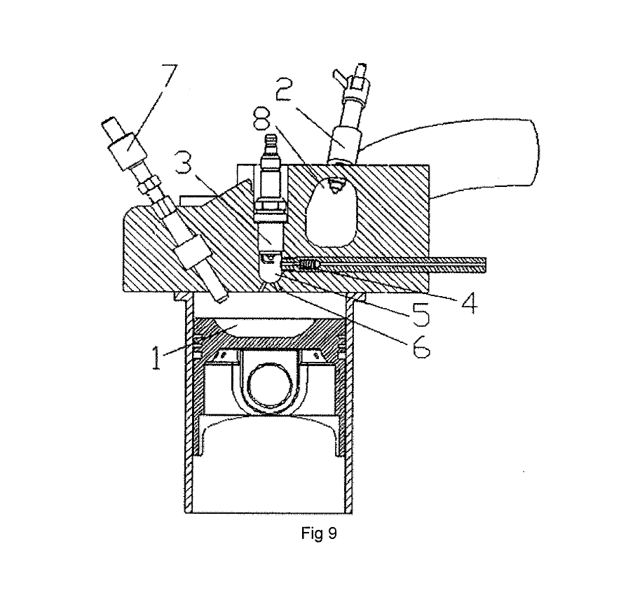

FIG. 8 shows that spark plug 3 and auxiliary spray nozzle 4 of an internal combustion engine are installed in combustion chamber 1. The main spray nozzle 2 and water injector 7 are installed in intake port 8.

FIG. 9 shows that spark plug 3 and auxiliary spray nozzle 4 of an internal combustion engine are installed in ignition chamber 5, water injector 7 is installed in combustion chamber 1, and main spray nozzle 2 is installed in intake port 8.

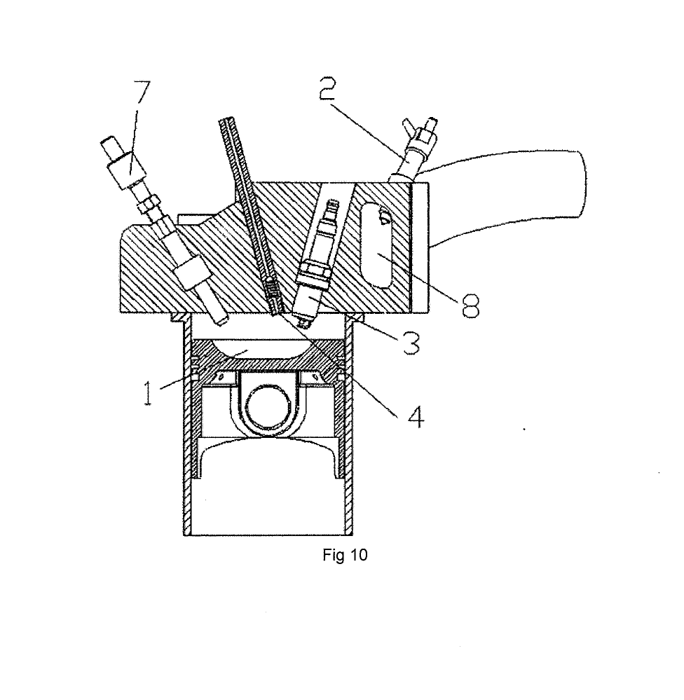

FIG. 10 shows that water injector 7, spark plug 3 and auxiliary spray nozzle 4 of an internal combustion engine are installed in combustion chamber 1, and the main spray nozzle 2 is installed in intake port 8.

FIG. 1 shows the multi-fuel premixed combustion system of the internal combustion engine system using spray-guide ignition: the chamber is designed to make the geometry compression ratio be 12, the intake valve closing time is designed to make the effective compression ratio be 9, and the intake charge is forced to be cooled after turbocharger. The main spray nozzle 2 utilizes hollow cone spray nozzle with good atomization and short spray tip penetration. During intake stroke, mixture of diesel fuel, gasoline and ethanol is injected directly into combustion chamber in order to form a homogeneous primary mixture with the volume fractions of 60%, 20% and 20% respectively. Due to the low initial temperature and low compression ratio, the auto-ignition of primary mixture is avoided under a compression temperature. At about 10° CA (crank angle) BTDC (Before Top Dead Center) of the compression stroke, the auxiliary spray nozzle 4 injects a gas mixture, 20% mass fraction hydrogen and 80% mass fraction CNG (Compressed Natural Gas), which is suitable for spark ignition to form a secondary mixture near spark plug 3 and auxiliary spray nozzle 4. The secondary mixture is ignited by spark plug 3 at 5° CA BTDC. The combustion of the rest primary mixture in combustion chamber 1 is initiated with the high temperature and high pressure produced by combustion of the secondary mixture near the spark plug 3. Consequently, the combustion timing of the three fuels in the combustion chamber 1 is effectively controlled. The combustion rate is controlled by part of cooled exhaust gas inducted in the intake charge, so the homogeneous mixture of the diesel fuel, ethanol and gasoline burns rapidly and smoothly under the low temperature. Experimental results show that NOx emission is reduced by 90%, soot emission is reduced by 92%, and the thermal efficiency is increased by 1.5%.

FIG. 4 and FIG. 6 show the multi-fuel pre-mixed combustion system of the internal combustion engine system using spray-guide ignition: the combustion chamber is designed to make the geometry compression ratio be 12, the intake valve closing time is designed to make the effective compression ratio be 9, and the intake charge is forced to be cooled after turbocharger. The main spray nozzle 2 utilizes hollow cone spray nozzle with good atomization and short spray tip penetration. During intake stroke, mixture of diesel fuel, gasoline and ethanol is injected directly into combustion chamber in order to form a homogeneous primary mixture with the volume fractions of 60%, 20% and 20% respectively. Due to a low initial temperature and low compression ratio, the auto-ignition of primary mixture is avoided under a compression temperature. At about 10° CA BTDC of the compression stroke, the auxiliary spray nozzle 4 injects a gas mixture, 20% mass fraction hydrogen and 80% mass fraction CNG, which is suitable for spark ignition to form a secondary mixture near spark plug 3 and auxiliary spray nozzle 4. The secondary mixture is ignited by spark plug 3 at 5° CA BTDC. The combustion of the rest primary mixture in combustion chamber 1 is initiated with the high temperature and high pressure produced by combustion of the secondary mixture near the spark plug 3. Consequently, the combustion timing of the three fuels in the combustion chamber 1 is effectively controlled. Combustion rate is controlled by EGR ratio at low and middle load. At high or full load, besides the EGR, water injector 7 is also driven to inject water spray to combustion chamber 1 or intake port 8. The combustion rate is controlled by the water spray and intake EGR, so that the multi-fuel premixed combustion can achieve full load with stable combustion, low combustion noise, and the engine protection. Experimental results show that, NOx emission is reduced by 90%, soot emission is reduced by 92%, thermal efficiency is increased by 1.5%, and the highest mean effective pressure can reach 2.5 MPa.

Ignition-chamber ignition is adopted in the multi-fuel premixed combustion system of an internal combustion engine, as shown in FIG. 2. The combustion chamber volume is designed so that the geometric compression ratio is 13 and intake valve closing timing is designed so that the effective compression ratio is 10. The intake charge is forced to be cooled after turbocharged. Main spray nozzle 2 is a high disturbance injector, which has good atomization effect and settable penetration. During the intake process, mixture of diesel fuel, gasoline and ethanol is injected into the combustion chamber 1 to form the homogeneous primary mixture, with the volume fraction of 50%, 40% and 10%, respectively. Due to a low initial temperature and low compression ratio, the auto-ignition of primary mixture is avoided under a compression temperature. At 70° CA BTDC, auxiliary spray nozzle 4 injects appropriate amount of compressed natural gas into the ignition chamber 5. Because the pressure in combustion chamber 1 is higher than that in ignition chamber 5 during the compression stroke, the gas in combustion chamber 1 flows to ignition chamber 5, which makes most of the natural gas sealed in ignition chamber 5 so that forming a CNG mixture suitable for ignition. At 5° CA BTDC, spark plug 3 discharges to ignite the mixture in ignition chamber 5. The pressure and temperature of the working fluid in ignition chamber 5 rises after burning. The flame goes into the combustion chamber 1 through the connecting channel 6 and stimulates the premixed combustion of primary premixed mixture. Thus the ignition timing of the three-fuel pre-mixture can be controlled in combustion chamber 1, and ignition timing controllable premixed compression ignition can be realized for the mixture of diesel fuel, gasoline and ethanol. The combustion rate can be controlled by importing cooled exhaust gas into the intake charge, ensuring the homogeneous mixture burning fast and smooth at lower temperature. Experimental results show that NOx is reduced by 95%, soot emissions are reduced by 95% and thermal efficiency of internal combustion engine is improved by 2.3%.

Ignition-chamber ignition is adopted in the multi-fuel premixed combustion system of an internal combustion engine, as shown in FIG. 3 and FIG. 5. The combustion chamber volume is designed so that the geometric compression ratio is 13 and intake valve closing timing is designed so that the effective compression ratio is 10. The intake charge is forced to be cooled after turbocharged. Main spray nozzle 2 is a hollow cone spray injector, which has good atomization effect and short penetration. During the intake process, mixture of diesel fuel, gasoline and ethanol is injected into the combustion chamber 1 to form the homogeneous primary mixture, with the volume fraction of 30%, 50% and 20%, respectively. Due to a low initial temperature and low compression ratio, the auto-ignition of primary mixture is avoided under a compression temperature. At 70° CA BTDC, auxiliary spray nozzle 4 injects appropriate amount of compressed natural gas into the ignition chamber 5. Because the pressure in combustion chamber 1 is higher than that in ignition chamber 5 during the compression stroke, the gas in combustion chamber 1 flows to ignition chamber 5, which makes most of the natural gas sealed in ignition chamber 5 so that forming a CNG mixture suitable for ignition. At 5° CA BTDC, spark plug 3 discharges to ignite the mixture in ignition chamber 5. The pressure and temperature of the working fluid in ignition chamber 5 rises after burning. The flame goes into the combustion chamber 1 through the connecting channel 6 and stimulates the premixed combustion of primary premixed mixture. Thus the ignition timing of the three-fuel pre-mixture can be controlled in combustion chamber 1, and ignition timing controllable premixed compression ignition can be realized for the mixture of diesel fuel, gasoline and ethanol. Combustion rate is controlled by EGR ratio at low and middle load. At high or full load, besides the EGR, water injector 7 is also driven to inject water spray to combustion chamber 1 or intake port 8. The combustion rate is controlled by the water spray and intake EGR, so that the multi-fuel premixed combustion can achieve full load with stable combustion, low combustion noise, and the engine protection. Experimental results show that, NOx emission is reduced by 96%, soot emission is reduced by 95%, thermal efficiency is increased by 2.8%, and the highest mean effective pressure can reach 2.4 MPa.

FIGS. 7, 8, 9, and 10 show the multi-fuel premixed combustion system of an internal combustion engine with multi-fuel injected into the intake port. The combustion chamber volume is designed so that the geometric compression ratio is 12 and intake valve closing timing is designed so that the effective compression ratio is 9. The intake charge is forced cooled after turbocharged. Main spray nozzle 2 is a hollow cone spray injector, which has good atomization effect and short penetration. During the intake process, mixture of diesel fuel, gasoline and ethanol is injected into the intake port 8 to form the homogeneous primary mixture, with the volume fraction of 30%, 50% and 20%, respectively. Due to a low initial temperature and low compression ratio, the auto-ignition of primary mixture is avoided under a compression temperature. At 10° CA BTDC, auxiliary spray nozzle 4 injects appropriate amount of compressed natural gas into the ignition chamber 5 (as shown in FIGS. 7 and 9) or into combustion chamber 1 (as shown in FIGS. 8 and 10) to form appropriate mixture around the spark plug 3. At 5° CA BTDC, spark plug 3 discharges to ignite the mixture in rest of the combustion chamber 1. Thus the ignition timing of the three-fuel pre-mixture can be controlled in combustion chamber 1, and ignition timing controllable premixed compression ignition can be realized for the mixture of diesel fuel, gasoline and ethanol. Combustion rate is controlled by cooled EGR rate. Water injector 7 is also driven to inject water spray to combustion chamber 1, as shown in FIGS. 9 and 10, or intake port 8, as shown in FIGS. 7 and 8. The combustion rate is controlled by the water spray and intake EGR, so that the multi-fuel premixed combustion can achieve full load with stable combustion. Since the intake port injection timing is early, same good mixture preparation similar with that of direct injection can be realized. Furthermore, system requirement for injection pressure and sealing performance of the fuel injection system can be lowered.

In addition, the said combustion system can not only inject multi-fuel, but also inject a single fuel such as diesel, gasoline or wide-cut fuel through the main spray nozzle directly.

According to the mentioned examples, this engine has a low compression ratio and high expansion ratio. The effective compression ratio is no larger than the least ratio which can make auto-ignition of the primary mixture. For turbo-charged engines, the forced cooling system for turbocharger gases is to make sure that the temperature of the gases in the intake port is low. During the intake stroke or the compression stroke, the blended fuel is injected into the combustion chamber to form primary mixture. The auxiliary spray nozzle injects appropriate volume fuel suitable for spark ignition, and then the spark plug ignites the secondary mixture. The high pressure and high temperature flame triggers simultaneous combustion of the primary mixture, thus the ignition timing of the premixed combustion can be controlled effectively. The combustion rate can be controlled with EGR and water injection into intake port and combustion chamber. Both main and auxiliary spray nozzles are shut off when idling. This kind of internal combustion engine has relatively high thermo efficiency because of the rapid combustion rate.

1-11. (canceled)

12. A multi-fuel premixed combustion system of internal combustion engines, comprising a combustion chamber (1), a main spray nozzle (2), a spark plug (3) and an auxiliary spray nozzle (4), wherein said main spray nozzle (2) is installed in the combustion chamber (1) or intake port (8), the primary premixed mixture is formed by fuel, which is a blended fuel injected by the main spray nozzle (2) into the combustion chamber (1) or intake port (8) during intake stroke or compression stroke, the blended fuel can be a mixture of two or more fuel, or a fuel suitable for compression ignition, or a fuel suitable for spark ignition, or a wide-cut fuel; the engine can be natural aspirated or supercharged; the effective compression ratio is set less than or equal to 14 with regard to natural aspirated, and when it is supercharged, the effective compression ratio is sent no more than 11; the supercharged air is cooled by a supercharger cooler, or by intake port water injection, or by direct water injection into the combustion chamber (1) to decrease the compression temperature to avoid the auto-ignition of the primary premixed mixture in the combustion chamber (1) caused by temperature rise due to compression; the secondary mixture suitable for spark ignition is formed around the spark plug electrodes by injecting a spark-ignition-suitable fuel or the same fuel as injected by the main spray nozzle with an auxiliary spray nozzle (4) just before or after TDC, and then the secondary mixture is ignited by a spark plug (3), leading to the rapid rise of pressure and temperature which triggers the multi-point simultaneous premixed compression ignition of the primary mixture in all the space of combustion chamber (1).

13. The multi-fuel premixed combustion system of internal combustion engines according to claim 12, wherein said main spray nozzle (2), spark plug (3) and auxiliary spray nozzle (4) are installed in combustion chamber (1).

14. The multi-fuel premixed combustion system of internal combustion engines according to claim 12, wherein an ignition chamber (5) is set in the cylinder head, said main spray nozzle (2) is installed in combustion chamber (1), spark plug (3) and auxiliary spray nozzle (4) are installed in the ignition chamber (5), there is at least one connecting channel between the combustion chamber (1) and ignition chamber (5).

15. The multi-fuel premixed combustion system of internal combustion engines according to claim 13, wherein water injector (7) is set in the said combustion chamber (7).

16. The multi-fuel premixed combustion system of internal combustion engines according to claim 14, wherein water injector (7) is set in the said combustion chamber (7).

17. The multi-fuel premixed combustion system of internal combustion engines according to claim 13, wherein water injector (7) is set in the said intake port (8).

18. The multi-fuel premixed combustion system of internal combustion engines according to claim 12, wherein water injector (7) is set in the said intake port (8).

19. The multi-fuel premixed combustion system of internal combustion engines according to claim 12, wherein, when said spark plug (3) and the auxiliary spray nozzle (4) are set in the combustion chamber (1), the main spray nozzle (2) and water injector (7) are set in the intake port (8).

20. The multi-fuel premixed combustion system of internal combustion engines according to claim 12, wherein, when said spark plug (3) and auxiliary spray nozzle (4) are set in the ignition chamber (5), the main spray nozzle (2) and water injector (7) are set in the intake port (8).

21. The multi-fuel premixed combustion system of internal combustion engines according to claim 12, wherein, when said spark plug (3) and auxiliary spray nozzle (4) are set in the ignition chamber (5), the main spray nozzle (2) is set in the intake port (8) and water injector is set in combustion chamber (1).

22. The multi-fuel premixed combustion system of internal combustion engines according to claim 12, wherein, when said spark plug (3), auxiliary spray nozzle (4) and water injector (7) are set in the combustion chamber (1), the main spray nozzle (2) is set in the intake port (8).

23. The multi-fuel premixed combustion system of internal combustion engines according to claim 12, wherein EGR is used to control the combustion rate.

24. The multi-fuel premixed combustion system of internal combustion engines according to claim 12, wherein the main spray nozzle (2) and the auxiliary spray nozzle (4) are shut off in idle condition when said internal engine is used as a vehicle power.
